(19) United States
(12) Patent Application Publication
(10) Pub. No.: US 2001/0022105 A1
(43) Pub. Date: Sep. 20, 2001

(54) Hazardous liquid underground storage and dispensing systems and method of installation

(76) Inventor: Chadbourne Daniel Ivory, Davis, CA (US)

Correspondence Address: Richard T. Holzmann, 2055 Imperial Ave., Davis, CA, 95616, US

(21) Appl. No.: 09/802,506

(22) Filed: Mar. 9, 2001

Related U.S. Application Data
(63) Continuation of application No. 09/281,177, filed on Mar. 30, 1999.

(51) Int. Cl. G01M 3/04

(52) U.S. Cl. 73/49.2

(57) ABSTRACT

An improved underground hazardous liquid storage system and aboveground dispensing system, said dispensing system placed immediately above said storage tanks. All storage, delivery and pollution monitoring functions of the stored liquid are self-contained in a fully transportable unit. Liquid storage has either double or triple wall protection. All electrical, controlling and monitoring functions are incorporated into the two units as shipped requiring only hook-up when the two units are installed at the operational site. The modular nature of this system provides simple installation, conservation of land and labor, while fully protecting the waters and soil of the earth and being readily removable to another location if desired or coupled with another system to provide greater capability.

This is a continuation-in-part application of patent application No. 09/281,177 filed on Mar. 30, 1999.

### FIELD OF THE INVENTION

This invention relates in general to the underground storage and aboveground dispensing of liquids and more particularly, to those that are environmentally hazardous to natural waters and soil.

### BACKGROUND

Prior to the 1980s, underground storage and aboveground dispensing of hazardous liquids from tanks and lines respectively were single wall in construction, unprotected, remotely configured, complex, expensive, time consuming to construct and a danger to the environment. In a gasoline service station setting, the opportunity for leakage existed in underground storage tanks, piping and pumps, in the vapor recovery stand pipe and piping, and in the aboveground dispensing units.

This remote configuration involved placement of (a) underground storage tanks at a distance from (b) the dispensing units, and (c) the controlling station at a distance from both (a) and (b). Product piping connects (a) with (b); while electrical wiring interconnects all three. Nevertheless, this system has an advantage in that the underground tanks are replenished while the liquid is being dispensed since the tanker supply trucks can refill the storage away from the dispenser islands. However, a major disadvantage lay in the expense and time-consuming nature of new construction coupled with the associated complicated permit process. Jurisdiction for the permitting of these systems prior to the 1980s, even before environmental concerns were addressed, included City Building and Fire Departments and/or County Fire Departments. Each agency required system approval to meet their own special regulations.

In a typical service station setting, the major phases of construction are:

1. Permitting;

2. Surveying and grading for tank farm and dispenser island placement;

3. Excavating, grading and installing:

(a) underground tanks, and

(b) dispenser islands;

4. Installing:

(a) underground product, vapor recovery and vent piping,

(b) electrical wiring for powering

1-tank pumps and dispensers, and

2-controlling each dispenser product;

5. Testing all tank, piping and dispenser functions;

6. Site surface grading where dispenser islands, tanks and venting are placed.

To complicate matters further: (1) this application is rated as Hazardous Class 1 Group D, thus all electrical wiring must be run separately through steel conduit pipe; and (2) the above is for only one liquid whereas, with four separate liquids the system at least quadruples, and the electricals and steel conduits increase even more. Permitting and constructing such systems is highly specialized and labor-intensive. These single walled systems permitted leakage into the water table and soil.

With the advent of environmental awareness, new laws and regulations at all levels of government were implemented mandating more positive storing/dispensing of hazardous liquids and their vapors and requiring detection/protection capabilities. The jurisdictions permitting these systems grew enormously and can now include: City Building Departments, County and Federal Environmental Protection Agencies, State Water and Environmental Control Boards, City and County Fire Departments, State Fire Agencies, City/County and/or State Air Quality Control Organizations. Each of these permit organizations developed their own set of requirements, conditions, review processes and fees to be met for permit approval. Thus, the cost and time involved in obtaining approvals has greatly increased particularly due to the need for individual designs to satisfy the different concerns of each jurisdiction.

As a consequence of the above, the normal design, construction and testing of these systems were drastically modified in many cases to guarantee a second containment of vapor and/or liquid leakage. Catch basins, containment boxes and pans were added to the tank fill and vapor recovery stand pipes, underground pumps and dispensers with appropriate sensors placed therein; tanks and piping were double walled with a sensor therebetween even as with vent piping in some instances.

Even with all these innovations, these new environmentally sensitive systems still had the separate “tank farm area” distinct from the “dispenser islands” and the “controlling station”. Therefore, they were still remotely configured except now they were far more complex, expensive and time consuming to construct. The cost of these revised systems has risen considerably and the arguments for and against their use have conflicted in two special areas; small business on the one hand and the environment on the other.

In most cases where these systems are required, the very large oil companies are the only ones that can afford them thereby forcing the small business “out of business.” Furthermore, the cost has risen so high that it prevents some jurisdictions from even enacting the laws that would require the environmental controls thereby undermining efforts to provide a cleaner and healthier environment. As a result, a new system is required to provide adequate environmental detection and protection while at the same time being affordable for both the small independant business and the small jurisdiction whose concerns for the water and soil of the earth are vital.

The most relevant prior art appears to be that found in U.S. Pat. No. 5,305,926 issued to Webb on Apr. 26, 1994. Webb discloses a portable fueling facility for aircraft or ground vehicles which includes at least one storage tank, and all the other associated equipment. Webb points out that, “It is clear there has existed a long and unfilled need in the prior art for a portable above-ground refueling facility for refueling aircraft or ground vehicles which has adequate protection against fuel leakage, is readily deployable at a desired refueling location and does not require an attendant to effect a refueling transaction.” (emphasis added) See column 1, lines 63-68 where Webb indicates that overcoming these problems is the object of his invention. Webb continues in column 1 at lines 28-30, “One significant disadvantage of such in-ground refueling stations was the time and labor involved in preparing such a facility.” And at lines 34-37, “Once installed, such facilities could not practically be moved to different locations at the airport, to other airports, or be sold.”

In the present invention, these problems with underground installation and storage are overcome with a far more versatile system than that of Webb. In addition, the subject invention solves the above problems even for a typical ground vehicle gas station having multiple products with their multiple storage tanks and multiple dispensing stations. This new system is integrated and can, nevertheless, be relocated.

Consequently, it is an object of the instant invention to provide a modular, yet fully integrated, self-contained unit that overcomes the deficiencies of the current systems.

It is another object to do this with a pre-manufactured, self-contained structure capable of being transported from the manufacturing plant to the installation site.

It is a further object to be able to install the subject invention in a matter of days rather than the months previously required. Similarly, it could be removed in a matter of days in order to transfer it to another location even on a lease basis.

It is an additional object to reduce the insurance cost of such an installation.

It is an object to provide a system which allows double containment or even triple for further protection of the environment at a much lower cost than the current remote systems.

It is another object to provide a modular system which can be installed quickly and inexpensively in small areas such as those that may be associated with a farm or even in a manufacturing or residential situation.

A further object is to identify a leak, shut down only the affected part while continuing operations in the non-affected portions.

It is still another object to allow real time access, in systems configured for access, by a person to all areas within the unit to make repairs on any portion of the underground system.

It is yet an additional object to reduce the grade surfacing and foundation pad requirement especially for the smallest applications such as for farm, manufacturing and residential use.

### SUMMARY OF THE INVENTION

The subject invention packages all the components that make-up the systems for underground storage and aboveground dispensing of liquid materials that are environmentally hazardous to the waters and soil of the earth. These packages are pre-manufactured, self-contained units which translate into an equipment commodity readily transported and installed at considerably lower cost than present day systems. While the most apparent application is for conventional car and truck gasoline/diesel service stations it is hardly limited to that. The pre-manufactured transportable and modular nature of the invention opens up new applications for the smaller user such as in manufacturing plants, farms and even in residential uses. Energy costs can be reduced for the smaller consumer by buying in bulk at more favorable prices when the price is at its lowest . . . and to do so with an environmentally safe installation. Of course, the entire concept of this invention applies equally well to those chemical applications of storing and handling hazardous solvents and other liquid chemicals.

### BRIEF DESCRIPTION OF THE DRAWINGS

The above and other objects, features and advantages of the present invention will be more clearly understood from the following detailed description taken in conjunction with the accompanying drawings, in which:

FIG. A is a schematic end view of an underground elliptical storage tank within a rectangular outer containment shell;

FIG. B is a schematic end view of a circular single tank system situated as with FIG. A, but having space available for a maintenance technician to enter, inspect and repair;

FIG. C is a schematic end view of two elliptical tanks within the outer containment shell containing a fill material (usually pea gravel) between the inner tanks and the walls of the containment shell;

FIG. D is a schematic end view of a rectangular tank within the containment shell in a most volume effective embodiment;

FIG. E is a schematic end view of an elliptical tank within an elliptical outer containment shell in a cost effective embodiment;

FIG. F is a schematic end view of the elliptical outer containment shell of FIG. E illustrating a strapping means for stabilizing it by fastening it to an underground foundation and securing pad in high water table sites.

FIG. G is a schematic end view of a circular outer containment shell containing two elliptical storage tanks surrounded by fill, frequently pea gravel, for providing additional support for the system;

FIG. H is a schematic end view showing a rectangular outer containment shell and a means for fastening it to an underground foundation and securing pad;

FIGS. I through L are schematic top and side views of alternative locations of an enclosed attendant station with respect to a PSC-A unit installed above a PSC-U unit; and

FIG. M is a schematic side view of a fully installed PSC-U unit, including dispensers but absent an attendant station, showing the inner workings of the entire installed system of the invention necessary to load into storage tanks, pump out therefrom and deliver hazardous liquids to a receiver therefor while monitoring for detecting leakage and control.

### DESCRIPTION OF THE PREFERRED EMBODIMENTS

For the purposes of presentation, there are in general two types of pre-manufactured, self-contained structural units (referred to as PSC) embodied in the invention. The first unit (PSC-U) is installed underground and encases everything needed to store and deliver liquid to grade surface 1 as seen in all of the figures. Storage of liquid within this unit may be in curved or rectangular-shaped tanks as shown in FIGS. A through FIG. E and FIG. G. Basically, tanks of any shape and size and their placement within the outer protective shell 2 can be accommodated. Outer shell 2, in a service station setting, would normally be made of steel with its outer surface covered with a corrosion protective coating, or other suitable structural materials. However, for many other chemical liquids, stainless steel, and various other specialized coatings and/or metals, reinforced fiberglass and the like are usually necessary. The second unit 10 (referred to as PSC-A that under certain conditions is an option) is not integral with the PSC-U as shipped but is hooked-up as installed aboveground and encases everything needed for the environmental and functional control of the underground storage and aboveground delivery of the stored liquid as shown especially in schematic FIGS. I through L. However, it must be emphasized that the PSC-U unit could stand alone without any PSC-A unit as seen in FIG. M.

The PSC-U unit is encased in a single, liquid-tight containment structure 2, the outside shell of the PSC-U coupled with the dispensers, provides everything needed for underground storage and the delivery of the stored liquid to the aboveground dispensing units for the end-user. Individual liquid storage tanks 3 can assume many different shapes, and in the case of chemicals many different materials of construction, such as elliptical as seen in FIGS. A, C, E, and G. Furthermore, FIG. A shows an elliptical storage tank 3 that snugly fits into containment structure 2. FIG. B, on the other hand, illustrates a circular tank leaving enough room within containment structure 2 to permit a person to go into 2 for inspection and maintenance. FIG. C shows two elliptical tanks 3 within structure 2 meanwhile illustrating the location 4 of pea gravel fill should this be required by code. FIG. D illustrates a rectangular structure 2 containing a rectangular storage tank 3 should that be desired to maximize storage capacity.

Turning to FIG. E, one finds a containment structure 2 which itself is curved as is storage tank 3; while FIG. G illustrates a circular containment structure 2 having two elliptical tanks 3 therein surrounded by pea gravel or similar fill 4.

FIGS. F and H show two different methods of securing a curved containment structure 2 and a rectangular containment structure 2 respectively attached to underground bases 5, typically concrete or other suitable material, to prevent movement of structures 2 with respect to bases 5. These underground foundation and securing pads 5 may be essential where there is a high water table. In FIG. F straps 6 secure curved tank 2 to base 5; in FIG. H lock-down units 7 are the means for preventing such movement of rectangular tank 2.

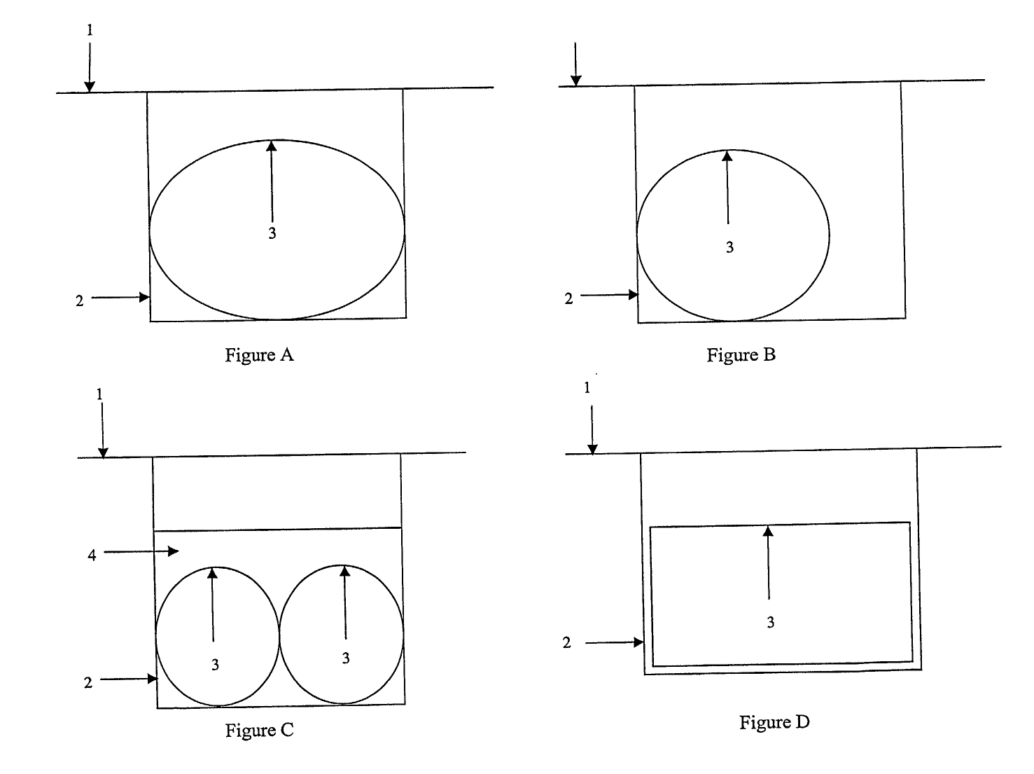

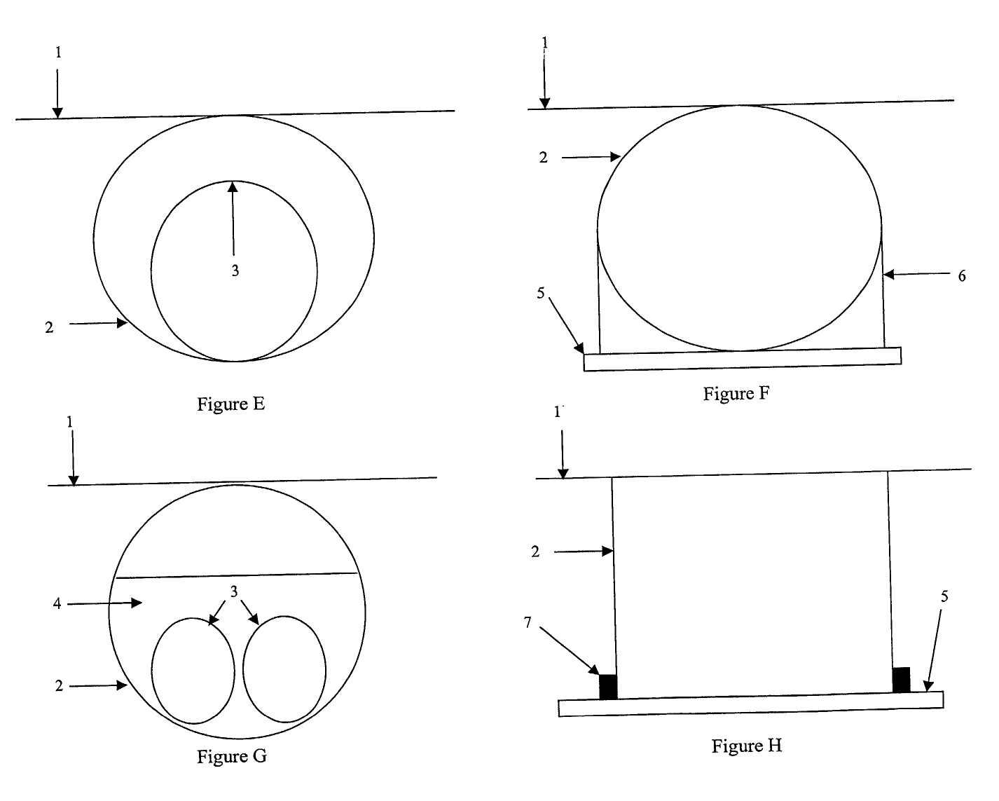

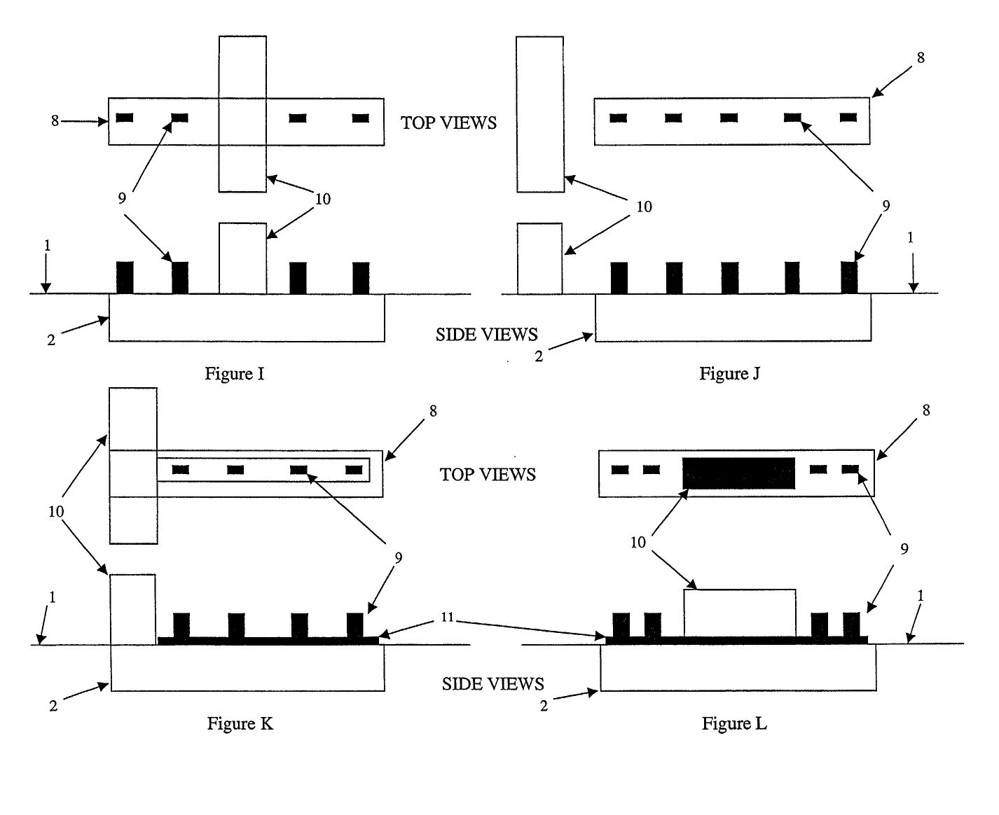

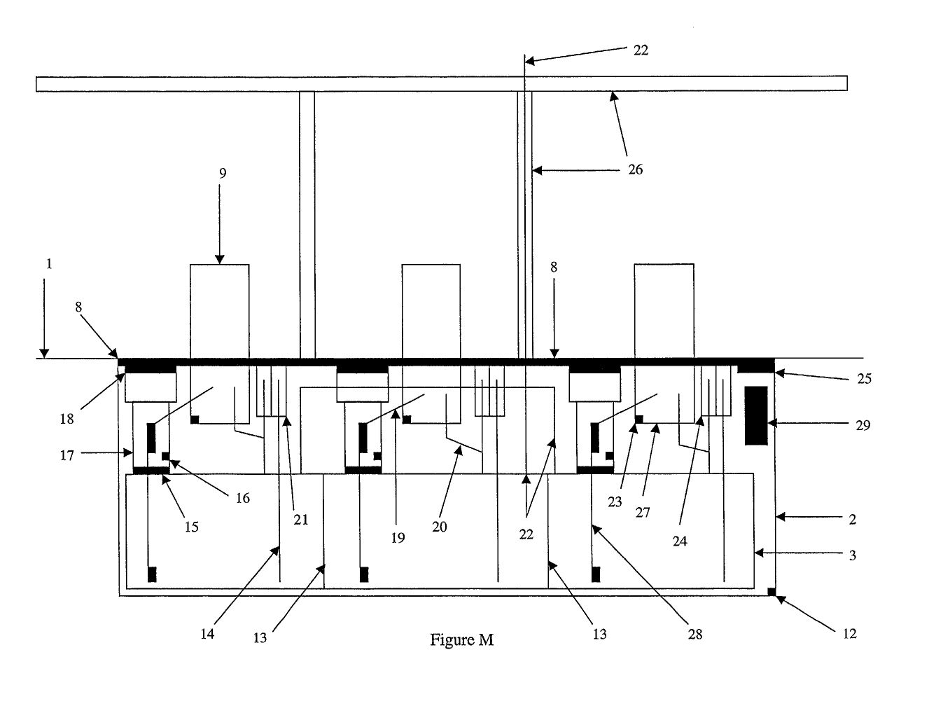

FIGS. I through L each contain top and side views to illustrate the various physical placements one may choose to locate aboveground structures 10 with respect to the aboveground liquid dispensers 9 which latter are connected to the top 8 of the PSC-U unit. Liquid dispensers 9 may be had from manufacturers such as Bennett, Gilbarco, and others. Of course, structures 10, which may be pre-fabricated, may be made an integral part of top 8 being perpendicular and overlapping PSC-U unit between dispensers 9 as in FIG. 1. They may also be perpendicular to and overlapping an end of the PSC-U unit as shown in FIG. K, wherein 11 is an above ground curb, often steel clad concrete, protecting dispensers from vehicle and water damage. They may also run linearly between dispensers 9 and totallly above the PSC-U unit as shown in FIG. L. On the contrary, structure 10 may be structurally totally removed from dispensers 9 and the top 8, probably also of steel clad concrete, of the PSC-U unit as shown in FIG. J. These dispositions are merely a matter of customer preference which may be due to the lay of the land, the number of dispensers desired and the extent of the aboveground structure 10, or for other individual preferences. Furthermore, requirements for larger systems allow the installation of additional interconnected PSC-U systems.

FIG. M illustrates the detail of the interconnected components of the PSC-U unit with a single underground tank 3 having three separate and baffled storage compartments for holding different liquids; for example, regular, high test and diesel fuels. In addition, this figure illustrates the aboveground dispensing cabinets 9, fill 14 and vapor recovery piping 20 with sensors 12, 16 and 23 for leak detection. Fill piping 14 is normally of aluminum encased in steel from the top of the tank to grade surface as supplied by the OPW company and others.

Baffles 13, usually of the same material as the tank, separate portions of the liquid internal storage tank 3 for different liquid products. In FIG. M, two baffles 13 and thus three separate tanks are identified. Manway access openings 15, provided by a number of suppliers are of steel or less expensive reinforced plastic, for each baffled portion of these liquid tanks are shown. Fill openings 14 for delivery of liquid to each baffled portion of the liquid containing tanks are also indicated. Underground liquid turbine pumps 28, made by Red Jacket, Gorman-Rupp and a number of others, in the baffled portions pump the liquids through liquid product lines 19, to the proper dispenser on demand. Liquid product lines 19 in a service station setting are ideally made of flexible alcohol compatible plastic supplied by Environ, Teleflex and others. Of course, for other liquid chemicals specialized materials need to be employed. Vapor return lines 20 are necessary when required for displacement of the vapors from the aboveground dispensing of liquid as well as for the supply of liquid to the underground tanks 3. A pipe 22 for venting the underground tanks 3 is also shown projecting through the canopy support and its top 26 into the atmosphere.

A number of containment boxes are used to surround various elements of the invention. For example, boxes 17, usually of reinforced fiberglass, are used to contain any liquid leakage from the turbine pumps 28 and their liquid product piping lines 19. Boxes 21 enclose the fill opening portions (where required) whereby liquid is delivered to the underground tanks 3 through fill pipes 14. Vapor return containment boxes 24 protect the areas delivering liquid to the underground tanks 3. Additionally, underground dispenser leak containment boxes 27 protect these portions of the system from liquid product pipe lines 19, dispensers 9 themselves, and vapor recovery lines 20 where these systems are enclosed by these boxes.

Furthermore, sensors are strategically placed to insure that alarms can be activated when liquids/vapors escape from their confined areas thereby presenting a potential for pollution of the soil or the atmosphere. A general sensor 12 is placed in a position to indicate liquid or vapor leakage within underground unit 2. Additional sensors 16 are placed within containment boxes 17 to detect any liquid or vapor leakage from the underground liquid turbine pumps 28 and their associated product lines 19 for both liquid and/or vapor. Finally, sensors 23 are placed within containment boxes 27 which are immediately beneath the aboveground liquid dispensers 9. Sensors, natually, are fabricated for the specific vapor/liquid involved. There are many suppliers for different kinds of chemical sensing. For the service station application one usually relies on one or another of the following suppliers: Veeder-Root, Vaporless, Red Jacket, FE Petro, and the like.

Maintenance access 25 for entrance into the entire PSC-U unit is also provided. It should be emphasized that the number of sensors required are strictly controlled by code. Finally, manway access openings 18 are provided for each underground liquid turbine pump containment box 17. It should be noted that permit requirements vary from state-to-state, county-to-county and city-to-city.

Both types of PSC are entirely manufactured in a factory and then transported and installed by truck and crane. The PSC-U unit embodies: all dispenser islands, all underground storage tanks, all piping and pumps, all sensors/wiring for system environmental detection/protection and central control 29. At this time, central control 29 would normally be fabricated of explosion proof commercially available electronic, electrical and petroleum components. However, in the near future it would probably be integrated by a computer controlled system. Of course, dispenser cabinets 9, though a part of PSC-U, are packaged and transported separately for on-site installation due to the height they would add in shipping. On the top of the PSC-U are the connections for quick installation of dispenser cabinets, vent piping, canopy attachment points, electrical power hook-up, and connection to the PSC-A unit where applicable.

As a general rule, most installations will have a PSC-A unit; however, this is not required as mentioned above. Master control system 29, in any case, is underground in shell 2 but can be interconnected aboveground io building 10 where an attendant is desired. Emergency shutdown and tank vent systems can also be supported in PSC-A. Different types of PSC-A units can also house a bathroom, freezers, refrigerators and all that is necessary to run a quick stop service station.

The PSC units can be transported from the manufacturing plant by truck to its installation site. It can also be transported in combination with the truck by boat, airplane and/or railroad. Installation of the PSC system can encompass many combinations of PSC units depending upon needed capacity and control.

Installation of the PSC system is relatively simple. The top portion of the PSC-U unit has an integrated surface finish of concrete or other suitable material completely ready for immediate use. The relevant bottom portion of the dispenser cabinets 9 mates with the relevant top portion of the PSC-U unit is pre-fabricated for instant connection on site. The steps for a complete installation of the PSC system with one PSC-U unit and one PSC-A unit are as follows:

1. The site is excavated, graded and prepared with a securing pad (when necessary), with power, water and sewer installed.

2. The PSC-U unit is lifted off the truck by crane, lowered into the ground and secured to its foundation pad where required. The PSC-A unit is lifted off the truck by crane and lowered onto grade surface.

3. The dispenser cabinets, vent piping, canopy and the PSC-A unit are connected.

4. The rest of the site is surface covered with asphalt or concrete and the PSC system is tested. Connection of the PSC-A unit to the PSC-U unit includes electrical power, dispenser control functions and environmental detection/protection controls.

It is optional to use the PSC-A unit with the PSC-U unit. If required, a separate building or control station can be constructed to house the dispenser control functions and environmental detection/protection controls. A single PSC-U unit installed by itself is all that is required for a fully functional PSC system for the underground storage and aboveground dispensing of liquid materials that are environmentally hazardous to the waters and soil of the earth. If extra storage of liquid is necessary and/or more aboveground dispensers are required above that for a single PSC-U, an additional PSC-U can be added to complete a larger overall system.

Everything encased in the PSC-U is secondarily contained since the outside structural shell 2 acts as the secondary containment barrier. With this arrangement, the single wall tanks and piping within the PSC, as well the product pumps and dispensers are protected by this double wall secondary containment provided by the PSC configuration. Triple wall containment for each of the major components is achieved when the tanks are integrally double walled, the product piping is integrally double walled, the product pumps are encased in containment boxes and dispenser outlets are set in separate dispenser pans encasing each dispenser cabinet.

The PSC-U unit stores the liquid in storage tank 3 and delivers it to the aboveground dispensers 9. Underground pump 28 transports liquid via piping 19 to dispenser 9 which then meters the liquid into a container, such as an automotive gas tank, for its final use. Vapor displaced by the liquid entering the vehicle can be returned to the PSC-U storage tank via piping 20. As for filling the PSC-U tanks, this is pumped from a delivery truck into tank fill openings 14 at surface grade. Similarly, the vapor displaced can be returned to the delivery truck via vapor recovery pipe 20.

Liquid and vapor sensors are placed within the PSC-U units at a number of locations to detect leakage within the unit thereby activating shutdown elements to prevent escape of the vapor/liquid into the atmosphere or surrounding soil. Typical sensors would be placed inside:

1. the PSC-U unit to alert sensor 12 to shut down the entire PSC-U unit;

2. underground pump containment boxes 17 to alert sensor 16 shutting down the product from its respective pump 28; and

3. aboveground dispenser pans 27 shutting down product from its respective pump.

The PSC-A unit when used in conjunction with the PSC-U system houses redundant controls. It can also house everything normally stocked in a small shop as seen in a 7-11® setup, for example. If the controls for dispensing liquid are not normally activated at the dispenser unit itself, they may be controlled from the PSC-A housing.

Thus the problems identified in the objectives outlined above have been overcome by the subject invention. By fabricating the system off site, there is freedom to customize each unit as required. Furthermore, land utilization is minimized as are labor costs involved in installation. Consequently, the small service station business can remain in business while maximizing the ability to detect and control potential pollution. In addition, the invention lends itself to use in association with a manufacturing plant, a farm or even a household when sized therefor.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An underground hazardous liquid storage and aboveground dispenser cabinet system comprising:
an outside protective containment shell constructed and configured for underground use for supporting therein hazardous liquid storage tanks, the shell with its contents being fully transportable;
means for transferring the liquid to said tanks;
means for transferring the liquid from said tanks to said aboveground dispensers for end use;
means for detecting leakage; and
means for preventing the detected leaking liquid and its vapors from entering the outside environment.

2. The liquid storage system of claim 1 wherein the outside shell is a secondary pollution containment barrier for the entire underground system for preventing leaked liquid and/or vapors from contaminating the environment.

3. The liquid storage system of claim 2 wherein the outside shell is a tertiary barrier when all said relevant liquid/vapor content elements are double-walled.

4. The liquid storage system of claim 1 wherein said tanks can be of any size, shape and material to maximize their capacity and/or economy for a given purpose.

5. The liquid storage system of claim 1 wherein the shell is pre-manufactured and self-contained and of a configuration for ground transport to an installation site by truck and crane.

6. The liquid storage system of claim 1 wherein the aboveground dispensing system is modularly packaged for shipment to site and for facile connection to the underground storage system.

7. The liquid storage system of claim 1 where the means for transferring said liquid to said tanks is accomplished by activating pumps on a liquid delivery vehicle.

8. The liquid storage system of claim 1 wherein the means for transferring said liquid from said tanks to said aboveground dispensers are turbine pumps activated on demand by said dispensers, when in a service station situation further comprising product lines of flexible alcohol compatible plastic.

9. The liquid storage system of claim 1 wherein the means for detecting leakage from said tanks, said pumps, and said dispensers and further comprising transfer piping and containment boxes, are strategically placed sensors within the containment shell.

10. The sensors of claim 9 wherein their placement is usually within the shell itself for detecting and activating shut down of the entire shell unit, within said containment boxes for shutting down said pumps and said transfer piping, and further comprising aboveground dispenser pans encasing each dispenser cabinet for shutting down product from said dispensers themselves.

11. The underground liquid storage system of claim 1 further comprising manway access openings to permit easy access by service personnel for inspection, repair and maintenance.

12. The system of claim 1 further comprising additional such systems which are interconnectable to provide a larger liquid storage and dispenser capability.

13. The liquid storage system of claim 1 further comprising pea gravel or like fill for surrounding and supporting said tanks where required by local code.

14. The underground liquid storage system of claim 1 further comprising a master central environmental/electrical/electronic/pumping/dispenser underground control of both the underground and aboveground components.

15. The underground and aboveground systems of claim 1 further comprising an optional separate structure interconnected therewith for attendant control of the entire system further comprising washroom and fast food-like capabilities.

16. The underground and aboveground systems of claim 1 wherein the installed combined systems are easily removable for transport to and reuse at another location.

17. A method of installation of an underground hazardous liquid storage and an aboveground dispensing system comprising the steps of:
excavating a hole at a site for insertion of a pre-manufactured, self-contained liquid storage system;
pouring a concrete foundation pad in said hole as required if in a high water table or earthquake prone area;
transporting the underground liquid storage system from the manufacturer to said hole;
inserting said liquid storage system into said excavated hole;
fastening said liquid storage system to said foundation by means of straps or locks as required;
transporting the aboveground dispensing system from the manufacturer to said site;
placing the dispensing system above the liquid storage system; and
interconnecting all related elements of the systems to each other.
